(19) United States
(12) Patent Application Publication
(10) Pub. No.: US 2003/0050719 A1
(43) Pub. Date: Mar. 13, 2003

(54) Pattern classifier capable of incremental learning

(76) Inventors: Lu Bao-Liang, Saitama (JP); Michinori Ichikawa, Saitama (JP)

Correspondence Address: BIRCH STEWART KOLASCH & BIRCH, PO BOX 747, FALLS CHURCH, VA, 22040-0747, US

(21) Appl. No.: 10/193,130

(22) Filed: Jul. 12, 2002

(30) Foreign Application Priority Data
Jul. 13, 2001 (JP) 2001-212947

(51) Int. Cl. G06F 17/00; G06F 155/00

(52) U.S. Cl. 700/91; 700/90

(57) ABSTRACT

The invention provides a pattern classifier capable of incremental learning. Two attractive features of this pattern classifier are that the convergence of learning is guaranteed and training time can be remarkably reduced. The pattern classifier realizes incremental learning in three main steps. Firstly, a multiclass classification problem is divided into two-class classification subproblems, and each of these two-class classification subproblems is further divided into a number of linearly separable subproblems, each of which has only two training data belonging to two different classes. Secondly, complete learning of each of the linearly separable subproblems is performed in parallel. Finally, the solutions to the original multiclass problem emerged by simply combining the solutions of the linearly separable subproblems according to two module combinations laws, namely the minimization principle and the maximization principle, respectively. Since the module combination laws are completely independent of the structure of individual trained modules and their performance, to add new training data to previously trained pattern classifier can be realized efficiently.

### BACKGROUND OF THE INVENTION

1. Field of The Invention

The present invention relates to a pattern classifier that is capable of incremental learning, and more particularly to a pattern classifier capable of incremental learning in which patterns of image, sound or voice can be classified in response to meaning, class, or category of the image, the sound or the voice based on training data obtained from such image, sound or voice by means of primary treatment.

2. Description of The Related Art

To construct a pattern classifier in a supervised learning fashion, it is generally required to give a number of training inputs and desired outputs. The aim of training a pattern classifier is to create boundaries between input patterns to be separated.

There are two main problems faced by existing methods in training pattern classifiers. The first problem is that almost all of practical pattern classification problems are linearly non-separable problems, and no any learning algorithms are available that can guarantee the convergence of learning linearly non-separable problems.

The secondproblem is that computing time required for training pattern classifiers becomes very lengthy in case of a large number of training data, although it is not so remarkable problem as to computing time required for training small pattern classifiers in the case where there is a small number of training data. In other words, when there is a large number of training data to be learned, training time becomes prolonged, resulting in a remarkable problem from a practical standpoint.

### OBJECTS AND SUMMARY OF THE INVENTION

The present invention has been made in view of the various problems as described above involved in the prior art.

An object of the present invention is to provide a pattern classifier capable of incremental learning in which the convergence of learning is guaranteed.

A further object of the present invention is to provide a pattern classifier capable of incremental learning in which training time can be remarkably reduced.

In order to attain the above-described objects, the pattern classifier capable of incremental learning according to the present invention has been constituted as described hereinafter.

(1) A large-scale, complex multiclass pattern classification problem is divided into a number of linearly separable subproblems, each of which consists of only two training data belonging to two different classes, and the solutions to the original multiclass classification problem are obtained by simply combining the solutions of all of the linearly separable subproblems. As a result, the convergence of learning is guaranteed in the pattern classifier capable of incremental learning according to the present invention.

(2) Training time is allowed to reduce remarkably through the use of a manner for emerging the solutions to the original multiclass classification problem from the solutions of related linearly separable subproblems, instead of directly solving the original multiclass classification problem.

(3) The task of learning a complex multiclass classification problem is transform into learning a number of linearly separable subproblems, each of which consists of only two training data belonging to two different classes. Since the solution to each of these linearly separable subproblems can be directly obtained from the corresponding training data and no iterative computation is required, very much faster training can be realized.

(4) A manner for incremental learning in the present invention is the one wherein very simple rules, namely, the “minimization principle” and the “maximization principle”, are applied. Thus, the pattern classifiers can be simply achieved. Besides, there is no need for retraining the whole system, but it is sufficient for retraining the corresponding modules when new training data is added to the pattern classifier.

According to the present invention as described above, it is possible to construct a pattern classifier that can learn several million training data belonging to several thousand different classes, and moreover, it becomes possible to efficiently add new training data belonging to new classes to the pattern classifier.

As described above, the mechanism of the pattern classifier capable of incremental learning is very simple according to the present invention, so that it is easily implemented in both software and hardware (electronic circuits).

Accordingly, a pattern classifier capable of incremental learning according to the present invention wherein a multiclass classification problem is divided into two-class classification subproblems, the two-class classification subproblems are further divided into linearly separable subproblems, the classification results of the linearly separable classification subproblems are integrated into the solutions of two-class class classification subproblems, and the results obtained by integration of the two-class classification subproblems are integrated into the solutions to the multiclass classification problem comprises incrementally a linearly separable classification means for implementing a linearly separable classification for separating the new training data from the training data that had been learned before inputting the new training data; and an integration means for integrating the classification results of the linearly separable classification means into the solutions of two-class classification subproblems in the case when the new training data is added.

Furthermore, a pattern classifier capable of incremental learning according to the present invention wherein a multiclass classification problem is divided into two-class classification subproblems, the two-class classification subproblems are further divided into linearly separable classification subproblems, each of which has only two training data belonging to two different classes, the classification results, which have been divided into the linear classification problems between input data of multiple components are integrated into the two-class classification subproblems, and the results obtained by integration of the two-class classification subproblems are integrated into the solutions to the multiclass classification problem comprises incrementally a linearly separable classification means for implementing a linearly separable classification for separating the new training data from the trining data that had been learned before inputting the new training data; the first integration means for integrating the classification results of the linearly separable classification means into the solutions of the two-class classification subproblems; and the second integration means for integrating the results obtained as a result of integration of the two-class classification subproblems by means of the integration means into the solutions of the multiclass classification problems in the case when the new input data is added.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is an explanatory view for explaining a multiclass classification problem;

FIG. 2 is a constitutional block diagram showing a conceptual constitution of a pattern classifier capable of incremental learning based on the present invention, which has been described in a treatise authored by the present inventors;

FIG. 3 is an explanatory view illustrating a manner for dividing a multiclass classification problem into six two-class pattern classification subproblems;

FIG. 4 is a pattern classifier used for solving the three-class classification problem shown in FIG. 3;

FIG. 5 is an explanatory view illustrating a manner for dividing a two-class classification problem into a number of linearly separable subproblems, each of which consists of only two training data belonging to two different classes.

FIG. 6 is a constitutional block diagram showing an internal structure of a module for solving a two-class classification problem shown in FIG. 5, which is divided into a number of linearly separable subproblems.

FIG. 7 is a constitutional block diagram showing changes inside a module in the case when a new data belonging to an existing class is added.

FIG. 8 is a constitutional block diagram showing changes inside a module in the case when a new training pattern belonging to an existing class is added.

FIG. 9 is a constitutional block diagram showing an internal structure of a module for adding a new training pattern belonging to a new class.

FIG. 10 is a constitutional block diagram showing changes in a module structure in the case when a new class is added.

FIG. 11 is an example illustrating a manner for adding new training pattern belonging to an existing class.

FIG. 12 is a constitutional block diagram showing an addition of a module structure accompanied by the addition of FIG. 11.

FIG. 13 is a constitutional block diagram illustrating a manner for adding new data belonging to an existing class.

FIG. 14 is a constitutional block diagram showing an addition of a module structure accompanied by the addition of FIG. 12.

FIG. 15 is a constitutional block diagram illustrating a manner for adding new data, which does not belong to an existing class.

FIG. 16 is a constitutional block diagram showing changes in a whole module structure accompanied by an addition of FIG. 15; and

FIG. 17 is a constitutional block diagram showing an internal structure of a module to be added.

### DETAILED DESCRIPTION OF THE PREFERRED EMBODIMENTS

In the following, an example of embodiments of a pattern classifier capable of incremental learning according to the present invention will be described in detail by referring to the accompanying drawings.

First, a principle to be a foundation of a pattern classifier capable of incremental learning according to the present invention will be explained.

(1) Basic Understanding of Problem in Pattern Classification

A pattern classification means distinction/classification of numerical information of multiple components, which has been subjected to a primary treatment, (for example, they are generally data or the like obtained by extracting principal components from a result of line segment information as a result of detecting edges or that of two-dimensional Fourier transform in case of pictorial image, and a harmonic spectrum of dominant frequency or the like in case of voice or electroencephalograms) from an input signal of raw data such as pictorial image, voice, and electroencephalogram (for example, they are generally two-dimensional bitmap information in case of pictorial image, and wave form information in case of voice or electroencephalogram) in response to their meanings, categories, ranks or the like.

Furthermore, a solution can be given also with respect to such a task that there are directly numerical information of multiple components without primary treatment of raw data as in DNA base sequence information, and a classification is made on the basis of similarity in this situation in accordance with the same manner as that of the present invention as described above. Accordingly, the task described above may be regarded as a problem of pattern classification in a broad sense.

Although the number of dimensions in numerical information of multiple components, which come to be input data of a pattern classifier, dependents upon a problem to be solved, an example with two-dimensional input will be described hereinafter for the sake of easy understanding. D

For a linearly separable problem, a one-dimensional line can be use to solve it in a two-dimensional plane. Likewise, a linearly separable problem with multidimensional input can be separated by a hyperplane.

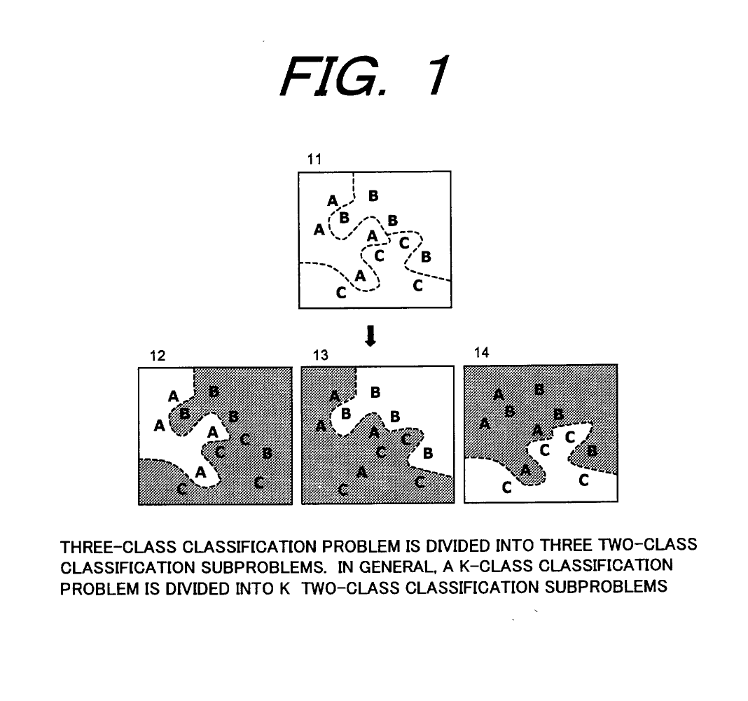

In a block represented by reference numeral 11 of FIG. 1, there are total twelve input data blonging to three classes A, B, and C (the term “class” is defined in the present specification as that means collectively classification, category, and rank), and these are represented by the respective characters. In FIG. 1, dotted lines are boundary lines for separating these three classes. In general, such boundary line is a complicated curve, so that it is difficult to directly determine such boundary line from training input data. Accordingly, it has been arranged heretofore in such that determination is made by means of learning in accordance with iterative calculation wherein neural network is used or the like manner.

A principle based on foundation of the present invention resides in a manner wherein such complicated curve is expressed by a combination of straight lines. According to the manner, boundary line can be positively obtained without accompanying any iterative calculation. The basic idea of this principle has been already described by the present inventors in a treatise (see “IEEE TRANSACTIONS ON NEURAL NETWORKS”, VOL. 10, NO. 5, SEPTEMBER1999, pp.1244-1256). In this connection, the treatise is indispensable for understanding of the present invention, so that the contents thereof will be described hereinafter by referring to the accompanying drawings.

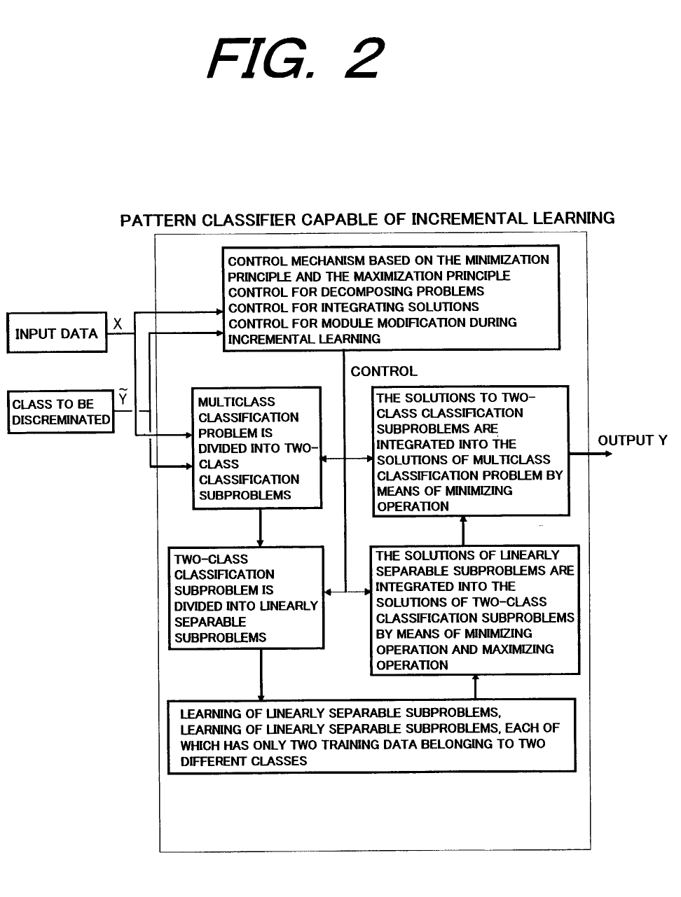

FIG. 2 is a conceptual block diagram showing a pattern classifier capable of incremental learning based on a principle being a foundation of the present invention disclosed in the above-described treatise.

In the pattern classifier capable of incremental learning shown in FIG. 2, a pair of given training input (X) and the corresponding desired output (\tilde{Y}) are presented simultaneously to the pattern classifier and with a class into which the input data X is to be classified, which is represented by the following numerical formula;

\tilde{Y}

to learn internally, and when only unknown input data X is input in case of after completing the learning, the pattern classification result can be output as Y.

The pattern classifier capable of incremental learning involves a constituent for executing a treatment wherein a multiclass classification problem is divided into two-class classification problems; a constituent for executing a treatment wherein a two-class classification problem is further divided into linearly separable subproblems; a constituent for executing a treatment wherein a linearly separable subproblem is learned; a constituent for executing a treatment wherein the problems capable of linear classification are integrated into a two-class classification problems by means of minimum value calculation and maximum value calculation; and a constituent for executing a treatment wherein the two-class classification problems are integrated into a multiclass classification problem by means of minimum value calculation. A control manner based on the “minimization principle” and the “maximization principle” corresponds to that of controlling these manners for problem decomposition and module integration.

In the pattern classifier capable of incremental learning according to the present invention, the control manner is applied in the case where a treatment relating to incremental learning, whereby convergence of learning is assured, and further a learning period of time can be remarkably reduced.

(2) Decomposition and Integration of Multiclass Classification Problem into Two-class Classification Problem

In the pattern classifier capable of incremental learning according to the present invention, such a treatment wherein a complicated problem is divided into simpler subproblems is implemented.

Reference numerals 12, 13, and 14 in their blocks of FIG. 1, respectively, indicate desirable boundaries each of which illustrates a situation wherein a boundary among those represented by reference numeral 11 divides only certain components as described hereinafter. Namely, reference numeral 12 in the block shows a boundary for dividing training data belonging to class A from others, which do not belong to the class A, (components belonging to class B and class C in this case) among boundaries represented by reference numeral 11 in the block. Likewise, reference numeral 13 in the block indicates a boundary for dividing components belonging to the class B from others, which do not belong to the class B, (components belonging to the class A and the class C in this case) among boundaries represented by reference numeral 11 in the block, and further reference numeral 14 in the block indicates a boundary for dividing components belonging to the class C from others, which do not belong to the class C, (components belonging to the class A and the class B in this case) among boundaries represented by reference numeral 11 in the block.

As a result of applying the above-described treatments, a three-class pattern classification problem in the block represented by reference numeral 11 is divided into three simpler classification subproblems. Such classification subproblem is a two-classification problem wherein whether a certain component belongs to a certain class or not.

Each white area bounded by a darkened area in a block represented by reference numeral 12, 13, or 14 shows an area belonging to each of classes (the class A in a block represented by reference numeral 12, the class B in a block represented by reference numeral 13, and the class C in a block represented by reference numeral 14).

In FIG. 1, a situation is indicated by a binarized expression whether components do belong to each class (truth) or not (false). However, in general, it may take a continuous value indicating a degree of analogy. For instance, when it is expressed by continuous values extending from zero (0) to one (1), a value is close to 1 in the vicinity of input data of the class A, the value is close to 0.5 in a part near to a boundary, and the value is close to 0 in the vicinity of input data of the class B with respect to the block represented by reference numeral 12.

Specific numerical data in the case where continuous values as described above are taken is decided by a function used for classification or the like.

However, for the sake of understanding a pattern classifier capable of incremental learning according to the present invention, it is necessary and sufficient to use an expression in the case when it was binarized. Accordingly, an expression, which has been binarized, is used in the following description for easy understanding of the invention.

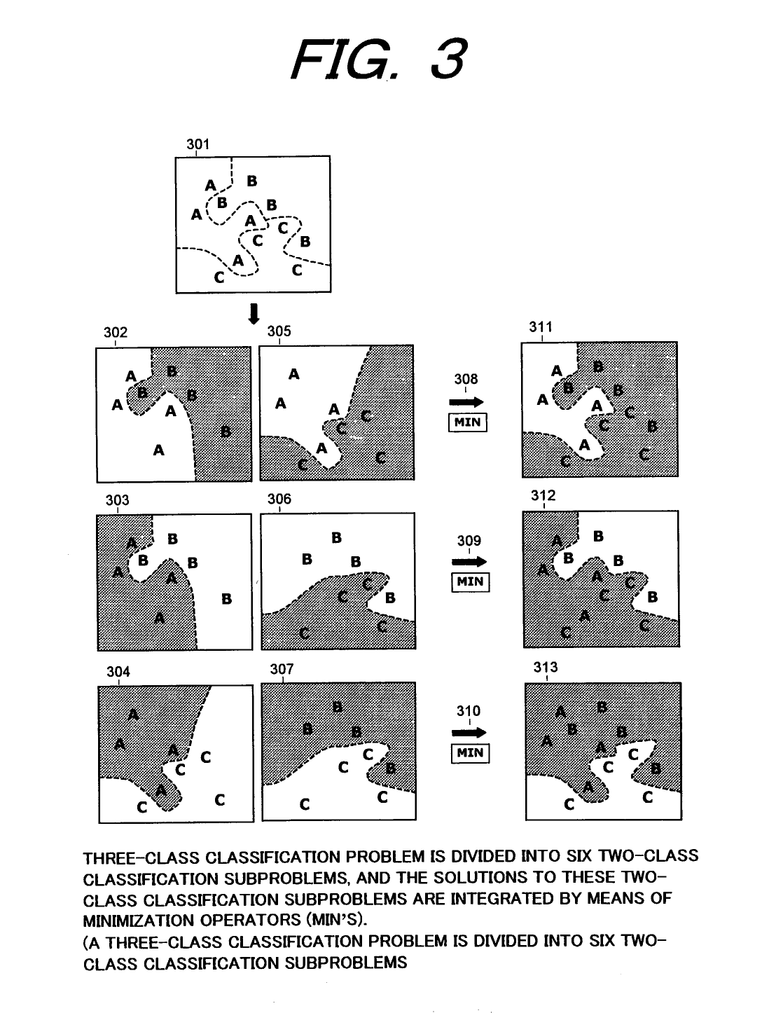

In this case, the three classification subproblems represented by the above-described reference numerals 12, 13, and 14 may be further divided into six relatively smaller and simpler two-class classification subproblems represented by reference numerals 302 through 307 in FIG. 3.

Namely, a classification subproblem represented by reference numeral 302 means to the effect that components belonging to a class C are removed from those contained in an original classification problem represented by reference numeral 301 (Existence of components belonging to the class C is ignored in a more pertinent description.), and components belonging to the class A from those belonging to the class B. That is, a white area bounded by a darkened area in the block represented by reference numeral 302 indicates the area of the class A.

Likewise, a classification subproblem represented by reference numeral 305 means to the effect that components belonging to the class B are removed from those contained in the original classification problem represented by reference numeral 301 (In a more pertinent description, existence of components belonging to the class B is ignored.), and components belonging to classes A are separated from those belonging to the class C. That is, a white area bounded by a darkened area in the block represented by reference numeral 305 corresponds to the area of the class A.

Moreover, a classification subproblem represented by reference numeral 306 means to the effect that components belonging to the class A are removed from those contained in the original classification problem represented by reference numeral 301 (In a more pertinent description, existence of components belonging to the class A is ignored.), and components belonging to the class B from those belonging to the class C. That is, a white area bounded by a darkened area in the block represented by reference numeral 306 corresponds to the area of the class B.

As is apparent from FIG. 3, a block represented by reference numeral 303 has a reverse relationship with respect to that represented by reference numeral 302. The block represented by reference numeral 303 is for dividing components belonging to the class B from those belonging to the class A wherein a white area bounded by a darkened area in the block represented by reference numeral 303 is the area for the class B.

Likewise, a block represented by reference numeral 304 has a reverse relationship with respect to that represented by reference numeral 305. The block represented by reference numeral 304 is for dividing components belonging to the class C from those belonging to the class A wherein a white area bounded by a darkened area in the block represented by reference numeral 304 is the area for the class C.

Furthermore, a block represented by reference numeral 307 has a reverse relationship with respect to that represented by reference numeral 306. The block represented by reference numeral 307 is for dividing components belonging to the class C from those belonging to the class B wherein a white area bounded by a darkened area in the block represented by reference numeral 307 is the area for the class C.

When a common part of a white area bounded by a darkened area that is defined by a block represented by reference numeral 302, which indicates to the effect that components are separated as those to be belonging to the class A (classification of components of the class A from those of the class B), and a block represented by reference numeral 305 (classification of components of the class A from those of the class C) is determined, a boundary in a block represented by reference numeral 311 wherein components of the class A are separated from those of the other classes is obtained.

The common part is obtained by determining a minimum value in a classification subproblem, which has been divided respectively, and in other words, when a minimum value operator (MIN) designated by reference numeral 308 is operated, the common part is obtained.

Minimum value operation by means of the minimum value operator 308 is equivalent to AND (logical product) of logical operation in the case where it covers a binarized boundary region as in white areas bounded by darkened areas, respectively, (truth) and the darkened areas bounded by white areas, respectively, (false) in the blocks represented by reference numerals 302 and 305.

Likewise, when a common part of a white area bounded by a darkened area that is defined by a block represented by reference numeral 303 (classification of components of the class B from those of the class A) and a block represented by reference numeral 306 (classification of components of the class B from those of the class C) is determined by the use of a minimum value operator (MIN) designated by reference numeral 309, a boundary in a block represented by reference numeral 312 wherein components of the class B are separated from those of the other classes is obtained.

Moreover, when a common part of a white area bounded by a darkened area that is defined by a block represented by reference numeral 304 (classification of components of the class C from those of the class A) and a block represented by reference numeral 307 (classification of components of the class C from those of the class B) is determined by the use of a minimum value operator (MIN) designated by reference numeral 310, a boundary in a block represented by reference numeral 313 wherein components of the class C are separated from those of the other classes is obtained.

These blocks represented by reference numerals 311, 312, and 313 are equivalent to those represented by reference numerals 12, 13, and 14 shown in FIG. 1, respectively. Namely, it means that an original classification problem is divided into classification subproblems, respectively, and when such a treatment wherein the minimum value of the classification subproblems divided is taken is applied, the divided classification subproblems can be integrated.

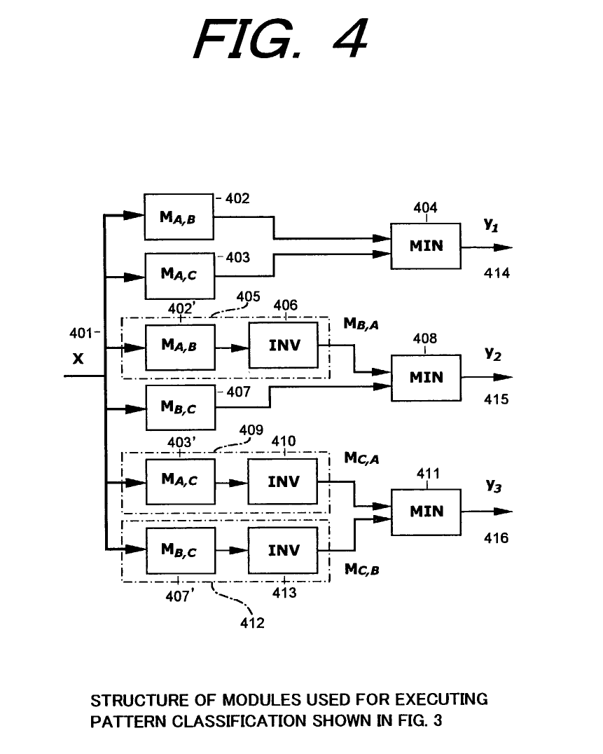

FIG. 4 is a constitutional block diagram for realizing a treatment of the manner shown in FIG. 3 wherein when input data is represented by X (reference numeral 401), a module 402 is the one for separating the input data X into the class A and the class B. When the input data X belongs to the class A, the module outputs 1 (one) (truth), while when the input data X belongs to the class B, it outputs 0 (zero) (false). This constitution corresponds to a circuit for obtaining an output corresponding to the block represented by reference numeral 302 in FIG. 3.

Likewise, a module 403 is the one for separating the input data X into the class A and the class C. When the input data X belongs to the class A, the module outputs 1 (truth), while when the input data X belongs to the class C, it outputs 0 (false). This constitution is a circuit for obtaining an output corresponding to the block represented by reference numeral 305 in FIG. 3.

Furthermore, a module 407 is the one for separating the input data X into the class B and the class C. When the input data X belongs to the class B, the module outputs 1 (truth), while when the input data X belongs to the class C, it outputs 0 (false). This constitution is a circuit for obtaining an output corresponding to the block represented by reference numeral 306 in FIG. 3.

On one hand, a module 405 is the one for separating the input data X into the class B and the class A, and a result of which is obtained by inversing an output of a module 402′ having the same function as that of the module 402 separating the input data X into the class A and the class B, i.e., the module 402′ having also the function for separating the input data X into the class A and the class B. For this reason, an inverter (INV) 406 is disposed in a subsequent stage of the module 402′.

The inverter 406 converts an output “1” of the module 402′ into “0” to output the same, while it converts an output “0” of the module 402′ into “1” to output the same (It is to be noted that when an output value of the inverter (INV) is a continuous value extending from zero (0) to one (1), “such an output value of the inverter=1- an input value into the inverter”). This constitution is a circuit for obtaining an output corresponding to a block represented by reference numeral 303 in FIG. 3.

In this connection, since the module 402 is the one for realizing the same function as that of the module 402′, it is not required to incrementally dispose the module 402′ as a component of the module 405 for separating the class B from the class A, when it is constituted in such that an output of the module 402 is used as that of the module 402′ in an actual circuit construction.

Likewise, a module 409 is the one for separating the input data X into the class A and the class C, and a result of which is obtained by inverting an output of a module 403′ having the same function as that of the module 403 for separating the input data X into the class A and the class C, i.e., the module 403′ having also the function for separating the input data X into the class A and the class C. For this reason, an inverter (INV) 410 is disposed in a subsequent stage of the module 403′.

The inverter 410 converts an output “1” of the module 403′ into “0”, while it converts an output “0” of the module 403′ into “1”. This constitution is a circuit for obtaining an output corresponding to a block represented by reference numeral 304 in FIG. 3.

In this connection, since the module 403 is the one for realizing the same function as that of the module 403′, it is not required to dispose incrementally the module 403′ as a component of the module 409 for separating the class C from the class A, when it is constituted in such that an output of the module 403 is used as that of the module 403′ in an actual circuit construction.

Moreover, a module 412 is the one for separating the input data X into the class C and the class B, and a result of which is obtained by inverting an output of a module 407′ having the same function as that of the module 407 separating the input data X into the class B and the class C, i.e., the module 407′ having also the function for separating the input data X into the class B and the class C. For this reason, an inverter (INV) 413 is disposed in a subsequent stage of the module 407′.

The inverter 413 converts an output “1” of the module 407′ into “0”, while it converts an output “0” of the module 407′ into “1”. This constitution is a circuit for obtaining an output corresponding to a block represented by reference numeral 307 in FIG. 3.

In this connection, since the module 407 is the one for realizing the same function as that of the module 407′, it is not required to dispose incrementally the module 407′ as a component of the module 412 for separating the class C from the class A, when it is constituted in such that an output of the module 407 is used as that of the module 407′ in an actual circuit construction.

Then, a minimum value operation unit 404 being a minimum value operator acquires a logical product of an output of the module 402 and an output of the module 403 to integrate the output of the module 402 and the output of the module 403, whereby a classification result Y₁ of the class A is output.

Similarly, a minimum value operation unit 408 being a minimum value operator acquires a logical product of an output of the module 405 and an output of the module 407 to integrate the output of the module 405 and the output of the module 407, whereby a classification result Y₂ of the class B is output.

Moreover, a minimum value operation unit 411 being a minimum value operator acquires a logical product of an output of the module 409 and an output of the module 412 to integrate the output of the module 409 and the output of the module 412, whereby a classification result Y₃ of the class C is output.

As described above, the classification result Y₁ of the class A, the classification result Y₂ of the class B, and the classification result Y₃ of the class C are obtained.

As has been explained in the above paragraphs, in a problem wherein input data is divided into multiclasses, only a relationship between two classes among them may be noticed to divide the problem. When a minimum value in results of the problem divided is taken out to integrate the results, the original problem can be solved.

(3) Decomposition of Two-class Classification Problem Between Data Thereof into One-to-one Linear Classification Problems and Their Integration

As to a two-class classification problem, a linear classification is generally impossible. In this connection, it is studied herein to the effect that the problem is divided to resolve itself into the one capable of linearly separable.

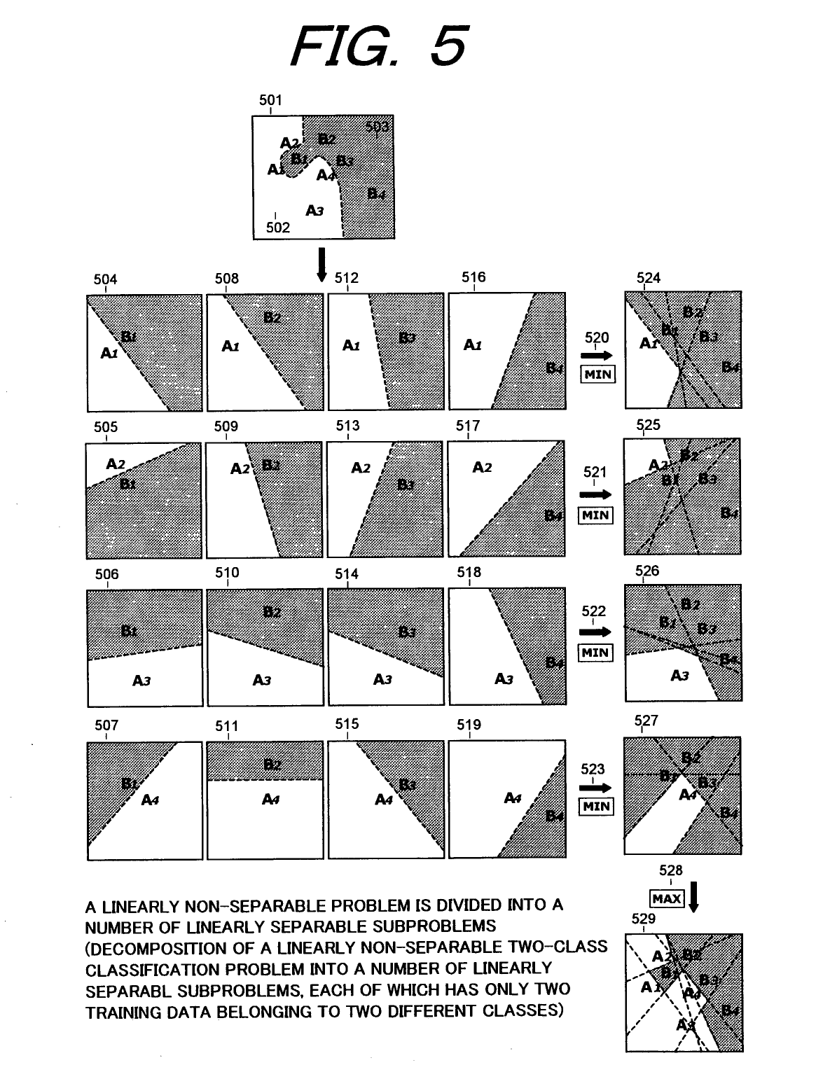

FIG. 5 illustrates a manner for dividing a two-class classification problem between classes A and B where in input data B1 takes a FIGURE in which it intrudes into the class A, so that a linear classification is impossible.

Since this problem is composed of four input data belonging to the class A and four input data belonging to the class B, relationships between these data exist in sixteen ways of their products. Considering the problem to divide into simpler two-class classification problems each of which contains only one data per class with respect to all the sixteen ways, classification boundaries and regions are determined.

First, those shown in a block represented by reference numeral 504 are regions separated by a straight line that separates in between two data of input data A1 and input data B1.

In the case where the number of data to be divided is two and they belong to different classes as described above, a linear classification is absolutely possible, so that linear classification can be made by means of straight line or simple hyperplane. The most pertinent straight line for classification boundary in this example is a line that is orthogonal with respect to a straight line extending between two points to be separated and that is positioned with an equal distance from these two points.

According to the same manner as that described above, a linear classification can be also achieved in the other fifteen ways as shown in blocks represented by reference numerals 505 through 519, respectively.

It is to be noted that any of those shown in blocks represented by reference numerals 504, 508, 512, and 516 is a solution relating to a classification problem of input data A1.

Accordingly, when these four blocks represented by reference numerals 504, 508, 512, and 516 are subjected to minimum value operation by means of a minimum value operation unit 520 to integrate them, a solution of classification problem of a class of the input data Al from that of input data B (a block represented by reference numeral 524) can be obtained.

Likewise, any of those shown in blocks represented by reference numerals 505, 509, 513, and 517 is a solution relating to a classification problem of input data A2.

Accordingly, when these four blocks represented by reference numerals 505, 509, 513, and 517 are subjected to minimum value operation by means of a minimum value operation unit 521 to integrate them, a solution of classification problem of a class of the input data A2 from that of input data B (a block represented by reference numeral 525) can be obtained.

Moreover, any of those shown in blocks represented by reference numerals 506, 510, 514, and 518 is a solution relating to a classification problem of input data A3.

Accordingly, when these four blocks represented by reference numerals 506, 510, 514, and 518 are subjected to minimum value operation by means of a minimum value operation unit 522 to integrate them, a solution of classification problem of a class of the input data A3 from that of input data B (a block represented by reference numeral 526) can be obtained.

Still further, any of those shown in blocks represented by reference numerals 507, 511, 515, and 519 is a solution relating to a classification problem of input data A4.

Accordingly, when these four blocks represented by reference numerals 507, 511, 515, and 519 are subjected to minimum value operation by means of a minimum value operation unit 523 to integrate them, a solution of classification problem of a class of the input data A4 from that of input data B (a block represented by reference numeral 527) can be obtained.

Then, when blocks represented by reference numerals 524, 525, 526, and 527 showing respective solutions of classification problems of respective points of the input data A1, the input data A2, the input data A3, and the input data A4 from the class of input data B are subjected to maximum value operation by means of a maximum value operation unit (MAX) 528 to integrate them, a solution of a classification problem of classes of input data A from classes of input data B shown in a block represented by reference numeral 529 is obtained.

In this case, when the maximum value operation conducted by the maximum value operation unit (MAX) 528 is aimed at a binarized classification region, it is equivalent to an OR (logical sum) of logical operation.

When the block represented by reference numeral 529 is compared with the block represented by reference numeral 302, the block represented by reference numeral 529 is approximated by a straight line, but it is understood that a borderline and a region similar to those of the block 302 represented by reference numeral 302 are obtained.

When a similar treatment to that described above is applied to a classification of the class A from the class C as well as that of the class B from the class C, any of class-to-class two-class classification problems corresponding to blocks represented by reference numerals 305 and 306 in FIG. 3 can be obtained by integration of the minimum value (or a logical product) of one-to-one linear classification problem between input data and the maximum value (or a logical sum) of the result.

Such nature can be mathematically proved, the subject matter thereof has been disclosed in the present inventors' treatise (see “Proc. of IEEE/INNS IJCNN, p. 159 to p. 164”).

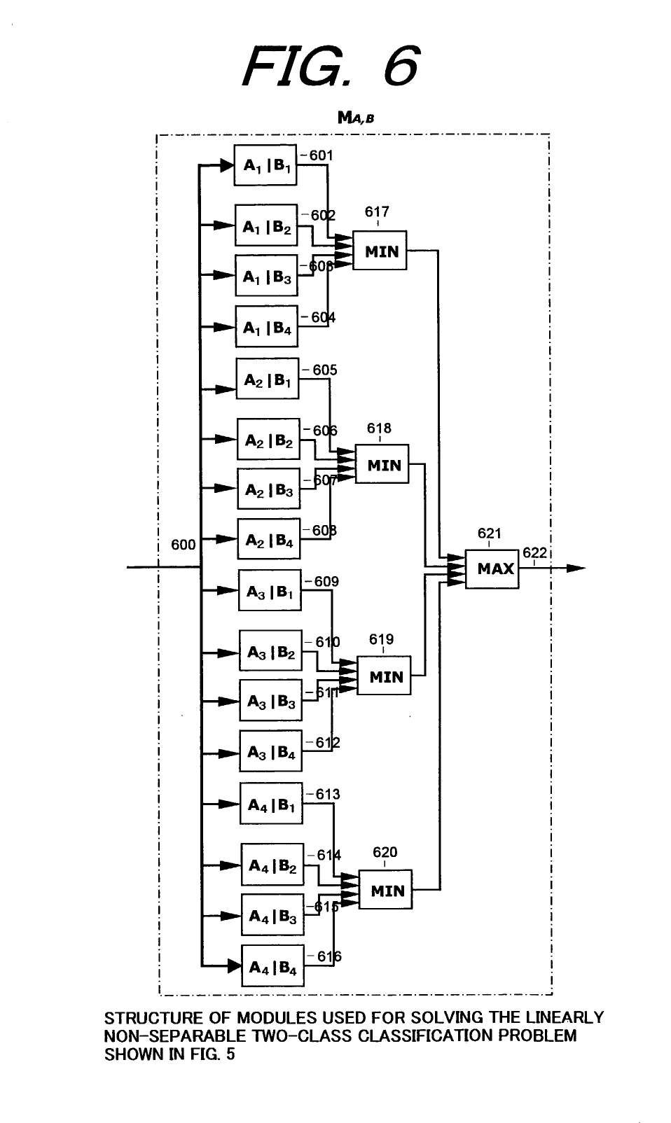

FIG. 6 is a constitutional block diagram showing modules required for classification treatments shown in FIG. 5 wherein a module 601 is that for implementing one-to-one linear classification of input data A1 from input data B1. The module 601 is the one for realizing a treatment in the block 504 represented by reference numeral 504 in FIG. 5 wherein output of the module 601 subjects the input data A1 and the input data B1 to one-to-one linear classification by means of a line or a hyperplane, so that a value becomes one (1) on a side near to the input data A1, while it becomes zero (0) on a side near to the input data B1.

Similarly, a module 602 is the one for conducting one-to-one linear classification of the input data A1 from input data B2, a module 603 is the one for implementing one-to-one linear classification of the input data A1 from input data B3, and further, a module. 604 is the one for conducting one-to-one linear classification of the input data A1 from input data B4; and respective modules output one (1) on a side near to the A1, while each module outputs zero (0) on each of sides near to the input data B2, B3, and B4, respectively.

Then, each common part of outputs from four modules of the module 601, the module 602, the module 603, and the module 604 is integrated by means of a minimum value operation unit 617 (In case of binarized output, integration is made in the form of AND (logical product)).

Likewise, a one-to-one linear classification treatment of input data A2 from the input data B1 is implemented in a module 605, a one-to-one linear classification treatment of the input data A2 from the input data B2 is implemented in a module 606, a one-to-one linear classification treatment of the input data A2 from the input data B3 is executed in a module 607, and a one-to-one linear classification treatment of the input data A2 from the input data B4 is conducted in a module 608, respectively, and the results obtained are integrated by means of a minimum value operation unit 618.

Further, a one-to-one linear classification treatment of input data A3 from the input data B1 is implemented in a module 609, a one-to-one linear classification treatment of the input data A3 from the input data B2 is implemented in a module 610, a one-to-one linear classification treatment of the input data A3 from the input data B3 is executed in a module 611, and a one-to-one linear classification treatment of the input data A3 from the input data B4 is conducted in a module 612, respectively, and the results obtained are integrated by means of a minimum value operation unit 619.

Moreover, a one-to-one linear classification treatment of input data A4 from the input data B1 is implemented in a module 613, a one-to-one linear classification treatment of the input data A4 from the input data B2 is implemented in a module 614, a one-to-one linear classification treatment of the input data A4 from the input data B3 is executed in a module 615, and a one-to-one linear classification treatment of the input data A4 from the input data B4 is conducted in a module 616, respectively, and the results obtained are integrated by means of a minimum value operation unit 620.

In these circumstances, when the respective results, which were integrated by these four minimum value operation units 617, 618, 619, and 620, respectively, are integrated by a maximum value operation unit 621, a superordinate module for solving a two-class classification problem of a class of input data A from a class of input data B can be constituted wherein the superordinate module for solving such two-class classification problem is referred to as “two-class classification module M_{A, B}”.

As superordinate modules for solving a two-class classification problem of the class of input data A from a class of input data C as well as a two-class classification problem of the class of input data B from the class of the input data C, the ones similar to the two-class classification module M_{A, B} shown in FIG. 6 are constituted, respectively, to be a two-class classification module M_{A, C}, and a two-class classification module M_{B, C}.

The two-class classification module M_{A, B} constituted as described above is used as a module 402 shown in FIG. 4, the two-class classification module M_{A, C} is used as a module 403 shown in FIG. 4, and further, the two-class classification module M_{B, C} is used as a module 407 shown in FIG. 4, respectively.

In this connection, the module 402 is equivalent to a module 402′, the module 403 is equivalent to a module 403′, and the module 407 is equivalent to a module 407′, respectively. Accordingly, when these modules are used, a pattern classifier for classifying input data X (reference numeral 401) into Y₁, Y₂, and Y₃.

Although the above description has been made with respect to a case where there are three classes, and four input data are involved in each class, it is possible to generalize the number of classes and the number of data in such pattern classifier.

Namely, if it is assumed that there are the number k of classes, and the number Li of input data is present in a class i (i=1, . . . , k), a multiclass classification problem of k classes maybe divided into the number “k(k-1)” of two-class classification problems.

A half of the two-class classification problems is the one having an inverse relationship as to a certain class, so that when it is operated inversely by the use of an inverter (INV), an equivalent result can be achieved. Accordingly, the number of such two-class classification problems required for calculating actually is “k(k−1)/2”.

In this connection, when it is assumed that arbitrary two classes among the number k of classes are a class u and a class v, the two-class classification problem may be divided into one-to-one linear classification problems between the number Lu.Lv of two input data.

Therefore, the one-to-one linear classification problems become a sum total up to “i=1, . . . , k” with respect to i and “j=j+1, . . . , k” with respect to j as a whole.

More specifically, the number of the sum total corresponds to the following numerical formula.

$${\sum }_{i = 1}^{k} {\sum }_{j = i + 1}^{k} Li \cdot Lj$$

In order to collect results with reference to these divided problems to integrate them, the following two principles of “minimization principle” and “maximization principle” are used.

The minimization principle means to the effect that “outputs of classification modules to be corresponded to problems each of them involves the same input the output of which becomes truth and a different input the output of which becomes false are integrated by a minimum value unit”.

On the other hand, the maximization principle means to the effect that “outputs of classification modules to be corresponded to problems each of them involves the same input the output of which becomes false and a different input the output of which becomes truth are integrated by a maximization value unit”.

It can be inevitably achieved by applying such two principles as described above that one-to-one linear classification problems are integrated into two-class classification problems, and further these two-class classification problems are integrated into a multiclass classification problem.

Besides, such a method for dividing a problem and a method for integrating problems based on these two principles are not dependent upon a specific problem. In other words, an algorithm for dividing a problem introduced from the above-described principle can be executed irrespective of knowledge about the problem.

On the basis of the above-described principle foundation, a classification problem for grouping patterns among multiclasses from a number of input data involving complicated boundary regions can be inevitably solved by the steps of dividing from a multiclass problem into two-class problems, and further dividing from the two-class problems into linear classification problems among respective input data, constituting a number of their simple modules separated, and integrating these outputs by means of the minimum value and the maximum value.

In addition, no repetitive operation is applied in the present method, so that a solution can be determined directly from the input data by means of calculation.

As are shown in constitutional block diagrams of FIGS. 4 and 6, although modules are numerous, a constitution of each module is simple. Besides, when its integration is made upon binarized operations, it is sufficient to handle only logical products and logical sums, so that they are easily treated with an electronic circuit (electronic circuits) or a computer (computers).

A pattern classifier capable of incremental learning according to the present invention is obtained by adding the following three characteristics to a pattern classifier constituted on the basis of the above-described principles.

(1) It is characterized by that when new input data belonging to a class which has been already present cannot be correctly separated in an existing pattern classifier, such new input data is incrementally learned.

(2) It is characterized by that when new input data, which does not belong to any class having been already present, such new input data is incrementally learned, and further a new class is added therefor.

(3) It is characterized by that the addition of the new input data described in the above paragraphs (1) and (2) can be made simultaneously with a usual pattern separating operation, so that no overall repetitive learning is required.

The characteristic features mentioned in the above paragraphs (1), (2), and (3) are those indispensable for an actual pattern classifier. Thus, when these characteristic features are added to the above-described principles, an extremely practical pattern classifier capable of incremental learning can be constituted.

In the following paragraphs (4), (5), and (6), a specific manner for realizing the above-described three characteristic features is explained.

(4) New input data is represented by reference character z. When the input data z is belonging to a class p contained in the number k of existing classes, each one-to-one linear classification module is constituted between the input data z and all the input data that have been learned and belonging to classes (the number of which is k−1) other than the class p. The total sum of which is represented by the following numerical formula.

$${\sum }_{{i = 1}_{i \neq p}}^{k} Li$$

These modules are added to each interior of two-class classification modules for separating the class p from classes other than the class p.

In these circumstances, when an arbitrary class other than the class p is indicated by a class q, the number of such input data that have been already learned and contained in the class p is Lp, which is represented by S₁, . . . S_{Lp}, respectively, while the number of input data that have been already learned and contained in the class q is Lq, which is represented by T₁. . . T_{Lq}, respectively.

In a constitution of such pattern classifier, since an operation is substituted by executing an inverse operation with respect to those which are two-class classification module shaving reverse relationships in the classes by the use of an inverter (INV), M_{q, p} does not exist, when there is M_{p, q}. Accordingly, there are the following two cases as to a manner for adding a one-to-one linear module to a two-class classification module.

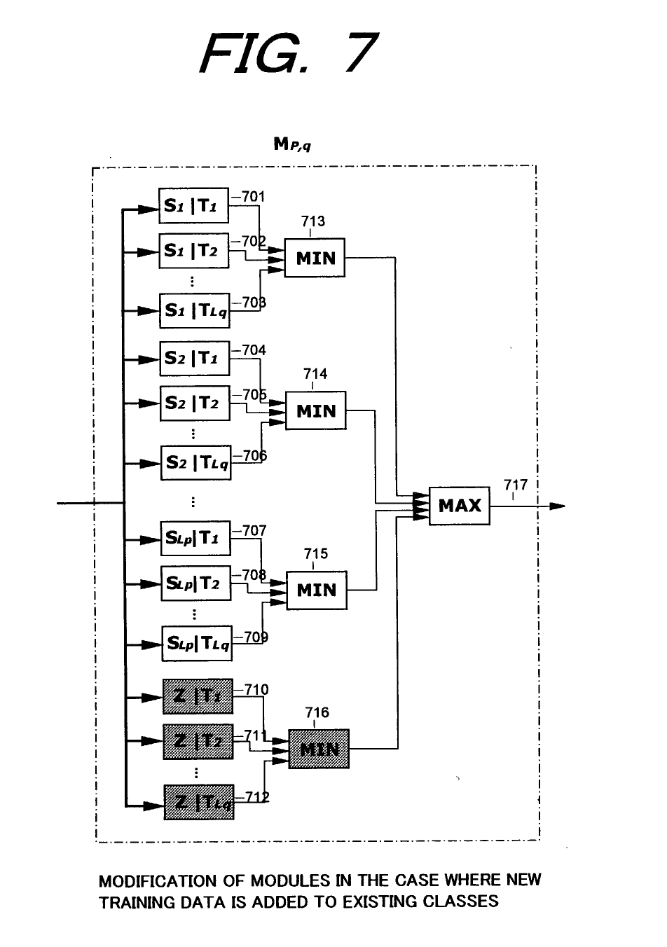

Namely, first, when there is the two-class module M_{p, q} for separating the class p from the class q, such a manner that the input data z and linear classification modules for separating the whole input data (T₁, . . . , T_{Lq}) that have been already learned and belonging to the class q are integrated by minimum value operation units, and their outputs are integrated again by means of a maximum value operation unit. In this connection, FIG. 7 shows the manner described above (It is to be noted that existing constitutions have been omitted in FIG. 7).

In the FIGURE, modules 701 through 709 of one-to-one linear classification module and minimum value operation units 713 through 715 are those which have been already present, while components to be added are modules 710, 711, and 712 that are one-to-one linear classification modules relating to the input data z as well as a minimum value operation unit 716.

Though a maximum value operation unit 717 has an existing constitution, an input connection from the minimum value operation unit 716 is added.

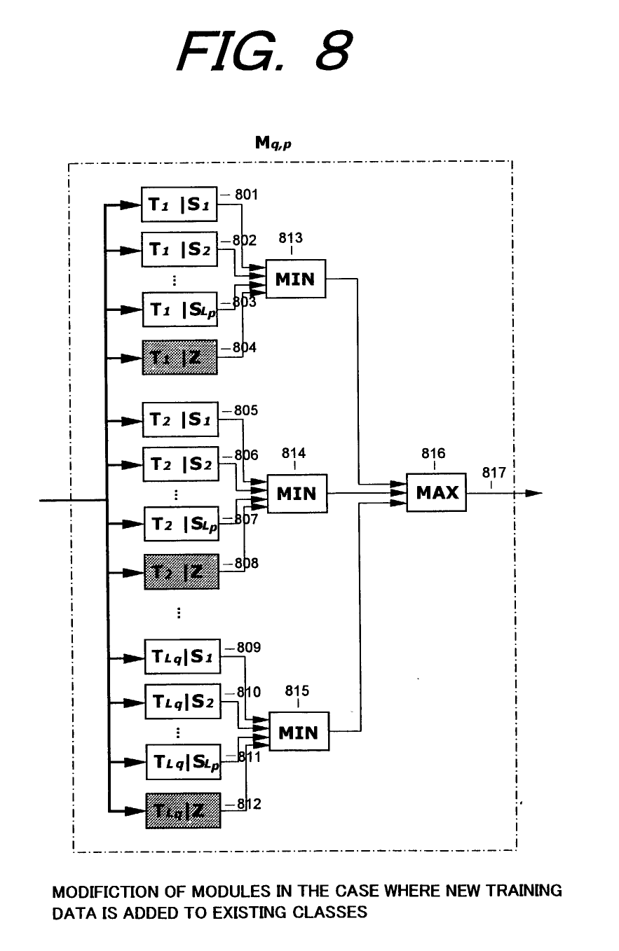

Then, second, when the two-class module M_{q,p} for separating the class q and the class p is present, linear classification modules for separating the input data z from the input data Ti (i=1, . . . , Lq) are aligned with linear classification modules for separating the input data S₁, . . . , S_{Lp} from the input data Ti, and they are integrated into their minimum value operation units, respectively. The manner described above is shown in FIG. 8 wherein there are the number Lq of changes in reality, but they are shown in an omitted manner to simplify the FIGURE for easy understanding.

In this case, for example, a new one-to-one linear classification module (module 804 ) is aligned with existing one-to-one linear classification modules (modules 801 through 803 ), and an output of the new module 804 is added to an input of a minimum value operation unit 813, thereby integrating the result obtained into the modules 801 through 803.

Likewise, as shown in FIG. 8, outputs of all the one-to-one linear classification modules that have been newly constituted (They are a module 808 and a module 812. In other words, one-to-one linear classification modules for each separating the input data Ti from the input data z.) are added to inputs of respective minimum value operation units (They are a minimum value operation unit 814 and a minimum value operation unit 816 ) to integrate the result obtained into an existing one-to-one linear classification module.

(5) When new input data is designated by reference character z and the input data z does not belong to any of the number k of existing classes, a new “k+1st” class to which the input data z belongs is constituted wherein the number Li of input data have been learned in a class i with respect to “i=1, . . . , k”, and j-th input data wherein j=1, . . . , Li in the class i is represented by the following numerical formula.

Xⱼ⁽ⁱ⁾

With respect to a new input data z to be added and all the learned input data belonging to all the classes (the number k of the classes) except for the “k+1st” class, which are represented by the following numerical formula;

Xⱼ⁽ⁱ⁾

a one-to-one linear classification module between data is constituted, and the number of a total sum of which is represented by the following numerical formula.

$${\sum }_{i = 1}^{k} Li$$

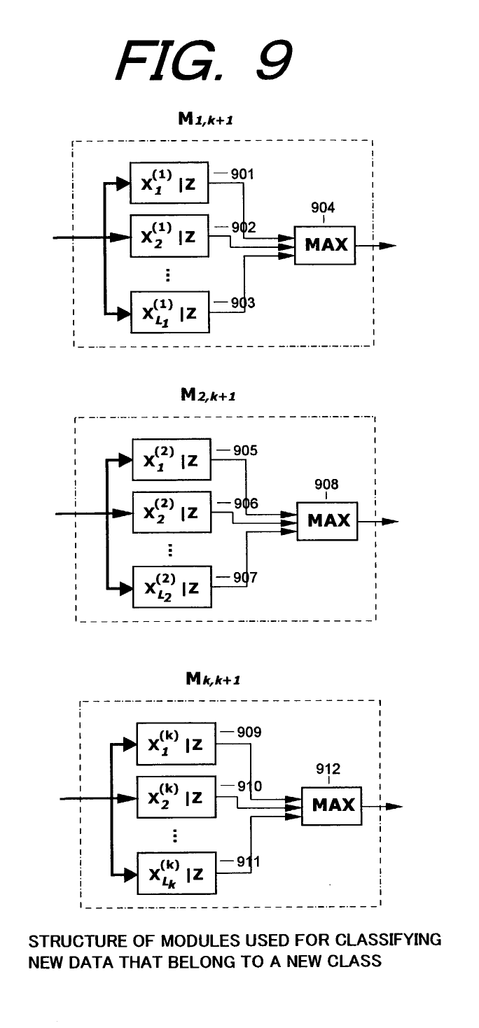

By the use of the linear classification module thus constituted, the number k of two-class classification modules M_{1, k+}(i=1,. . . , k) are constituted. The interior of each two-class classification module is arranged to involve a constitution determined by minimization principle and maximization principle. In other words, an interior of each of the modules M_{1, k+1}has such a constitution wherein linear classification modules between the input data z and all the input data belonging to the class i are integrated by means of a maximum value operation unit. This manner is illustrated in FIG. 9 wherein only three two-class classification modules among the number k of them extending from M_{1, k+1} to M_{k, k+1} are shown for simplifying the FIGURE to attain easy understanding.

As mentioned above, the one-to-one linear classification modules for each separating the input data z in every input data belonging to the respective classes are integrated by a maximum value operation unit.

In this case, while it is not required to use a minimum value operation unit in an internal structure of a two-class classification module to be added, a nominal minimum operation unit of one-input may have been previously disposed between an output of each linear classification module and an input of a maximum value operation unit, if such a possibility that input data is added to the class k+1 in the future is taken into consideration.

Then, these two-class classification modules are added to a constitution determined by minimization principle to complete a multiclass separator.

More specifically, the number k of newly constituted two-class classification modules M_{1, k+1}(i =1, . . . , k) are added to minimum value operation units for obtaining classification results of an existing class i, respectively, and results obtained by inverting all the M_{1, k+1} (by means of an inverter: INV) for the sake of acquiring classification results with respect to a new k+1st class are integrated by the minimum value operation units, whereby the multiclass separator is completed.

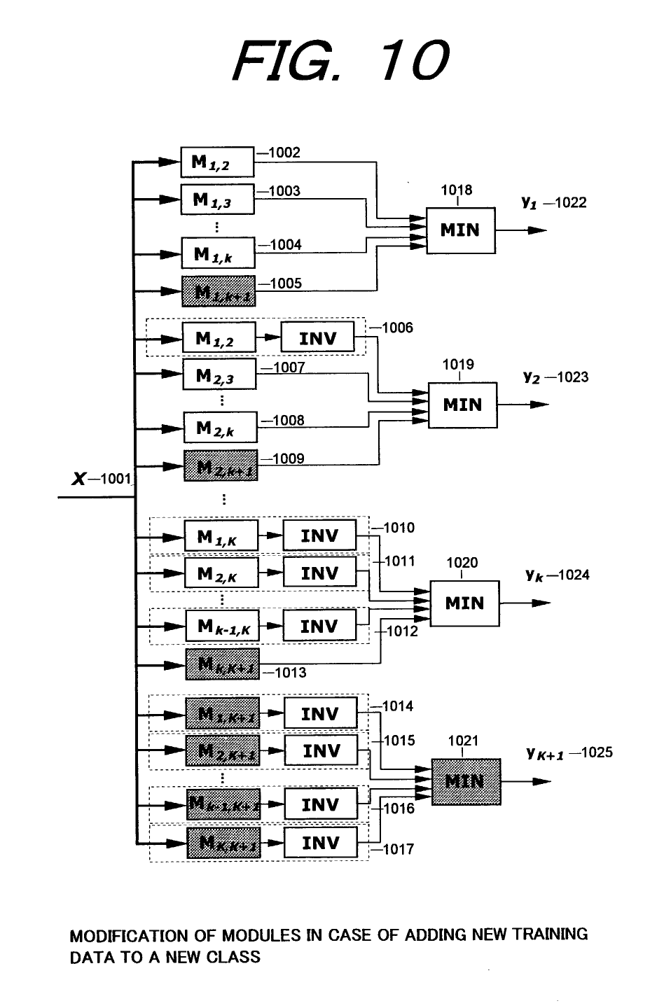

FIG. 10 illustrates such manner as mentioned above wherein only three modules among the number k of modules to be added and minimum value operation units for separating new classes are shown for simplifying the FIGURE to attain easy understanding.

Modules 1005, 1009, and 1013 are two-class classification modules added, respectively. When outputs of a group of modules (modules 1014 through 1017 ) for separating k +1st class synthesized by means of inversion operation of the two-class classification modules added and invertors (INV) are integrated, classification output Yₖ₊₁ of the new k+1 class is added.

(6) The number of linear classification modules to be added in the linear classification modules to be added that have been explained in the above-described paragraphs (4) and (5) corresponds to either the number of all the input data that have been learned, or the one determined by subtracting the number of data belonging to the same class from the former number of all the input data. The resulting number is remarkably small as compared with the number of all the linear classification modules.

For instance, when problems of each of the number k of classes are subjected to learning by means of the number n (i.e., Li=n, i=1, . . . , k) of input data, a total number of linear classification modules is “k×(k−1)×n²/2”. However, the number of linear classification modules required for incremental learning is “k×n” or “(k−1)×n”.

In other words, the number of linear classification modules necessary inevitably for incremental learning is less than that of whole learning in case of “k>2” and “n>2”. From a practical standpoint, since it is sufficiently expected to be “k>100” and “n>100” or more, incremental learning can be completed for an incommensurable short period of time as compared with that of the prior art.

Hence, it becomes possible to execute incremental learning at the time when an error arose, or at the time when new data is intentionally added while continuing pattern classification operation.

(7) Deletion of data that has been learned and deletion of classes

Under the circumstances where the above-described pattern classifier capable of incremental learning is operated, when partial data that has been already learned comes to be unnecessary, or when erroneously learned data is desired to delete, such deletion can be easily realized by conducting reverse procedures of the above-described manner for adding data.

Specifically, in order to delete data Sv belonging to a class p and that has been already learned, it is sufficient to implement only such a treatment that one-to-one linear classification modules between data relating to that designated by reference character Sv are simply deleted, and further that one input line of minimum value operation units for integrating the above-described one-to-one linear classification modules is deleted. Furthermore, when the minimum value operation units for integration become unnecessary, these minimum value operation units are deleted.

Moreover, when the whole class p becomes unnecessary, the two-class classification modules to which the class p relates, such as modules M_{p, 1} or M_{1, p} are deleted from the whole module structure. Then, an input line is deleted from minimum value operation units for integration relating to the two-class classification modules, and minimum value operation units for integrating outputs of the class p are deleted.

In case of the above-described deletion, if there is such a possibility that data or modules to be deleted come to be necessary in the future, it is sufficient to cut off logically a connection extending from outputs of the modules related to minimum value operation units (Specifically, it is sufficient to maintain a situation, which is always in truth logically.), but do not delete the modules themselves and the units themselves.

In the following, an explanation will be made more specifically with reference to similar drawings to those used in the above description of the principles for the sake of making an understanding of the descriptions in the above paragraphs (4), (5), and (6) easy.

It is presupposed in an exemplification applied for the explanation that known input data is learned by a pattern classifier constituted in accordance with the above-described explanation of principles, so that correct linear classification modules are established with respect to grouping classification of input data heretofore, and the outputs thereof exhibit adequate classification characteristics.

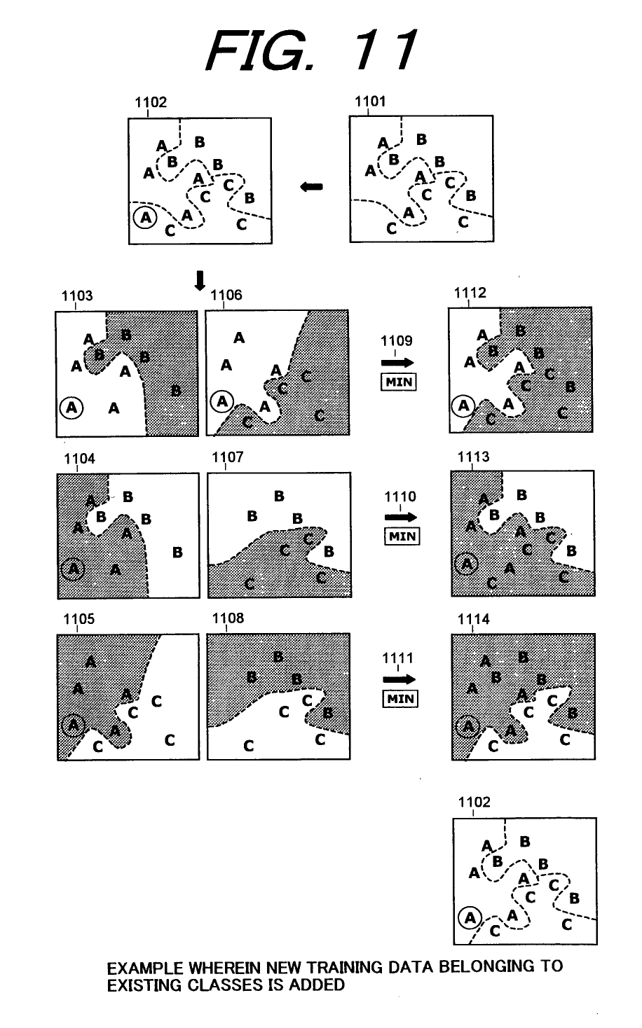

Specific characteristics of the exemplification are shown in a block represented by reference character 1101 in FIG. 11, which are the same as those used in the above-described explanation for principles (see FIG. 1 through FIG. 6) wherein there are three classes (k=3) A, B, and C, and four input data (L_{A}=4) belonging to the class A, four input data (L_{B}=4) belonging to the class B, and four input data (L_{C}=4) belonging to the class C are data to be learned, respectively.

From these components, a total forty-eight (48) of linear classification modules of input data verses input data are constituted.

The total forty-eight of the linear classification modules thus constituted are integrated by means of minimum value operation units and maximum value operation units, whereby three of two-class classification modules that are constitutionally equivalent to those shown in FIG. 6 are produced per each of the classes A, B, and C wherein they are designated by M_{A, B}, M_{A, C}, and M_{B, C}, respectively.

It is supposed that a pattern classifier, which may achieve the results of multiclass classification having the constitution shown in FIG. 4, has been prepared by integrating outputs of these two-class classification modules M_{A, B}, M_{A, C}, and M_{B, C} by the use of inverters (INV) and minimum value operation units.

(8) Exemplification of incremental learning in the case where new input data belongs to an existing class p

When new input data belongs to any of existing classes, the whole module structure (see FIG. 4) is not required to change. Namely, interiors of the class p to which new data belongs and of two-class classification modules in all the classes except for the class p are changed.

There are the following two cases (8-1) and (8-2) in the changing manner, because a half of the two-class classification modules are substituted by inverse operations with the use of inverters (INV).

(8-1) In the case where two-class classification module M_{p, q} (q is not p, but may be any number of from 1 to k) for separating a target class exists

In the following description, an explanation is made under such condition that p=A, and q=C. When input data belonging to the class A represented by a symbol A surrounded with a circle o (hereinafter referred to simply as “oA”) is input to a pattern classifier by which a boundary has been learned in a block represented by reference numeral 1101 in FIG. 11, its output is erroneously output as the class C, but not the class A. In this case, it is required to change the boundary in such that oA is correctly separated as the class A.

In order to learn input data of oA, a change in a boundary between the classes A and C is required. Namely, it is required to add linear classification modules of the input data of oA versus all the input data belonging to the class C, i.e., a total four input data versus the input data.

As a consequence, when the boundary between the class A and the class C is changed in such that the oA belongs to the class A as shown in a block represented by reference numeral 1106, the purpose is achieved.

When a boundary between the class A and the class C as well as a boundary between the class A and the class B containing the new input data oA are integrated by means of minimum value operation units, a correct two-class classification result is obtained as shown in a block represented by reference numeral 1112.

A block represented by reference numeral 1105 showing a state of two-class classification between the class C and the class A means inverse operation of the block represented by reference numeral 1106, and this is renewed automatically from a superordinate module structure, so that addition thereof is not particularly required.

In general, when new data belonging to an existing class is added, it is required to add input data related, which has been already learned, a linear classification module defined between the input data and new input data, and an integrated part of their outputs.

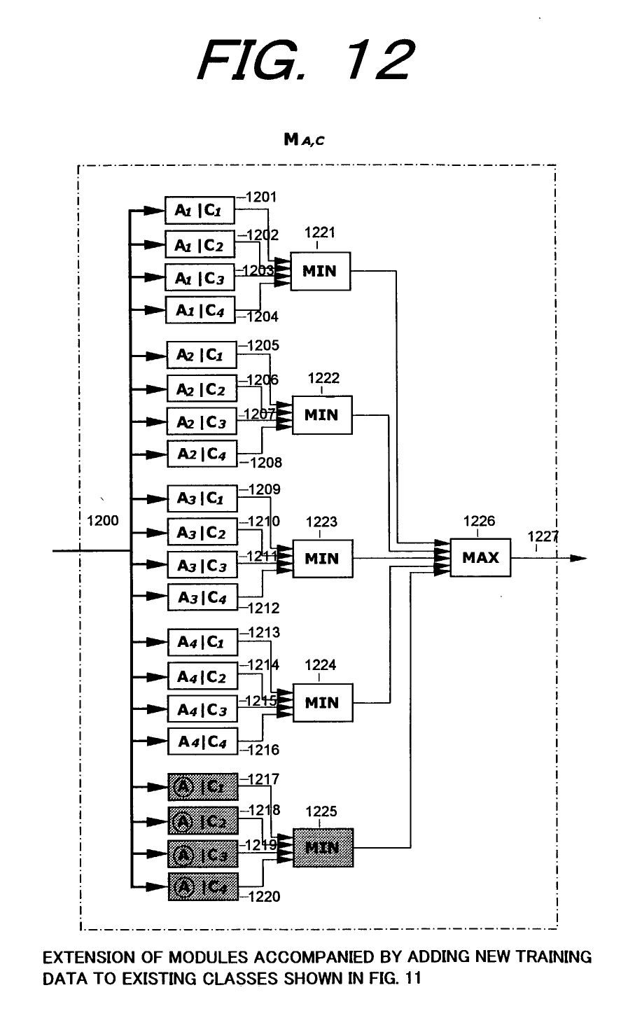

FIG. 12 is a block diagram showing an interior of a two-class classification module M_{A, c} between the classes A and C to which a new input data oA was added.

A structure of the constitutional block diagram shown in FIG. 12 before adding the two-class classification module M_{A, C} is similar to that shown in FIG. 6. However, an example of the class A versus the class B is shown in FIG. 6, while the class A versus the class C is shown in FIG. 12, so that it is necessary for replacing components “B1”, “B2”, “B3”, and “B4” in FIG. 6 by those “C1”, “C2”, “C3”, and “C4”.

Furthermore, modules 1201 through 1216 in FIG. 12 are constitutionally the same with those 601 through 616 shown in FIG. 6, and they are existing linear classification-modules. On one hand, those, which were added in FIG. 12, are linear classification modules 1217 through 1220, a minimum value operation unit 1225, and an input line for inputting an output from the minimum value operation unit 1225 to a maximum value operation unit 1226.

Namely, linear classification modules 1217 through 1220 are those for input data oA that is to be learned newly and input data C1, C2, C3, and C4 that belong to the existing class C and have been already learned. In order to integrate them, the minimum value operation unit 1225 is used, and further one input line is added to the maximum value operation unit 1226 for connection to integrate the whole components.

In the present embodiment, as may be analogized by a block represented by reference numeral 1103, it seems that there is no need for changing a two-class classification module between the class A and the class B. However, it is not usual, but it is required to add the input data oA in accordance with a similar operation that four linear classification modules for separating the data oA from that of the class B, respectively are prepared, and the input data oA is also added to a two-class classification module M_{A, B} between the class A and the class B.

In this respect, however, it is not required to change a two-class classification module M_{B, C} between the class B and the class C that is irrelevant to the class A.

(8-2) In the case where two-class classification module M_{q, p} (q is not p, but may be any number of from 1 to k) for separating a target class exists

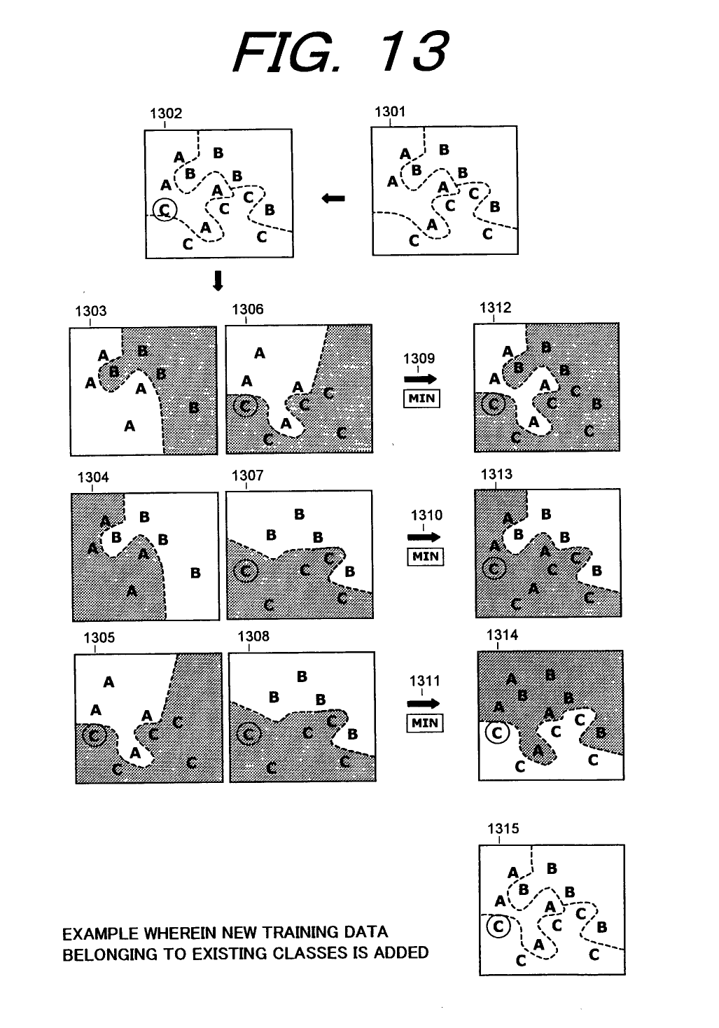

In the following description, an explanation is made under such condition that p=C, and q=A. A block represented by reference numeral 1301 in FIG. 13 shows input data that has been learned by an existing pattern classifier and their boundary regions wherein it is considered that input data belonging to the class C represented by a symbol C surrounded with a circle o (hereinafter referred to simply as “oC”) is incrementally learned. Basically, this purpose is achieved by changing a border defined by the class C and the class A in accordance with the same manner as that described in the above paragraph (8-1).

For this purpose, data-to-data linear classification modules are added in response to the input data oC and all the data belonging to the class A. In this connection, since the number of learning data is four, linear classification modules to be added are four. In this respect, since no module M_{C, A} does not exist in the original module structure as shown in the modules 409 and 410 in FIG. 4, an inverted result M_{A, C} is used.

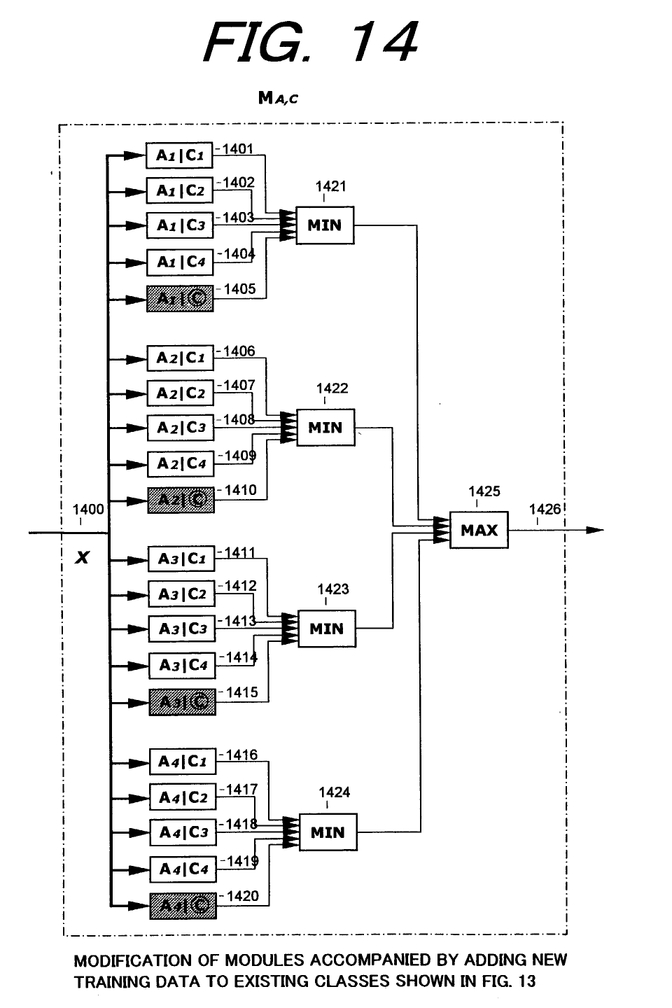

Accordingly, the linear classification module prepared comes to add to the result M_{A, C}. In this case, as in the internal constitution of the M_{A, C} shown in FIG. 14, one each of linear classification modules 1405, 1410, 1415, and 1420 that have been newly prepared is added to minimum value operation units 1421, 1422, 1423, and 1424 that integrate all the input data of the class A (input data A1, A2, A3, and A4 ).

In the present embodiment, as may be analogized by a block represented by reference numeral 1307, it seems that there is no need for changing a two-class classification module between the class C and the class B. However, it is not usual, but it is required to add the input data oC in accordance with a similar operation that four linear classification modules for separating the data oC from that of the class B, respectively are prepared, and the input data oC is also added to a two-class classification module M_{B, C} between the class C and the class B.

In this respect, however, it is not required to change a two-class classification module M_{A, B} between the classes A and B that is irrelevant to the class C.

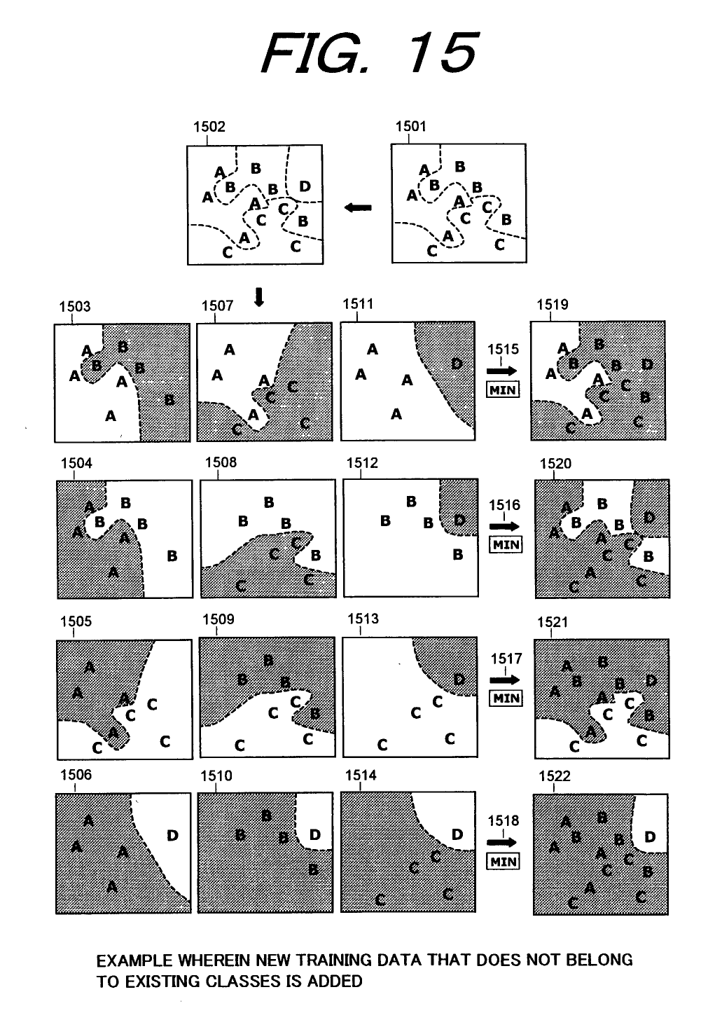

(9) Exemplification of incremental learning in the case where new input belongs to a new class, but not an existing class Since the new input belongs to the new class, but not the existing class, first, a “k+1” class is increased. As a result, a whole module structure changes. In FIGS. 15 through 17, an example wherein “k=3”, and “k+1 =D” is shown.

In this example, it is studied that a new input data D as shown in a block represented by reference numeral 1502 is incrementally learned in an apparatus indicating existing pattern separating characteristics as shown in a block represented by reference numeral 1501 in FIG. 15.

Since a class D is provided with respect to new data D, three of a two-class classification module between the class A and the class D (M_{A, D}), a two-class classification module between the class B and the class D (M_{B, D}), and a two-class classification module between the class C and the class D (M_{C, D}) are added in response to all the existing classes (the class A, the class B, and the class C), respectively.

It may be anticipated that each classification characteristics of them are to be the ones those shown in a block represented by reference numeral 1511, a block represented by reference numeral 1512, and a block represented by reference numeral 1513, respectively.

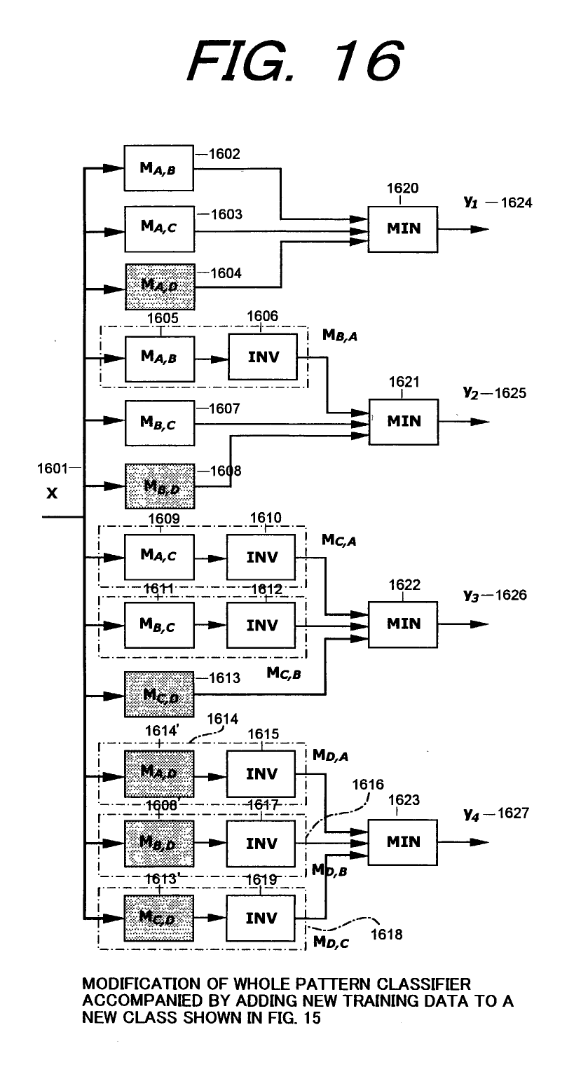

The three of new two-class modules are added to existing module structures as shown in FIG. 16. Those added to the components in FIG. 16 are a module M_{A, D} 1604, a module M_{B, D} 1608, and a module M_{C, D} 1613; inverted units of them, i.e., a module 1614, a module 1616, and a module 1618; and a minimum value operation unit 1623 for integrating these inverted units.

Furthermore, input lines for integrating the module M_{A, D} 1604, the module M_{B, D} 1608, and the module M_{C, D} 1613 that were added are added also to existing minimum operation units 1620, 1621, and 1622, respectively.

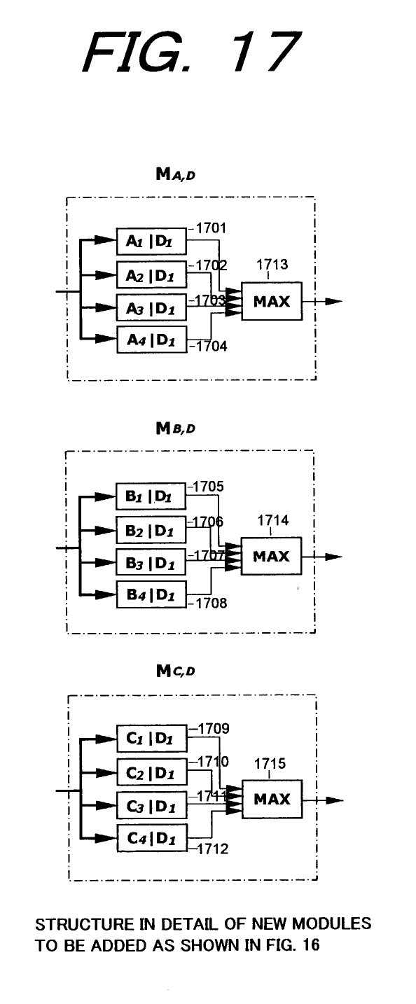

The interior of each two-class classification module is constituted as shown in FIG. 17. Namely, linear classification modules constituted between any of all the input data A1, A2, A3, and A4, which belong to the class A and have been already learned, and new input data D are integrated by means of a maximum value operation unit, respectively. A difference between each of these two-class classification modules and each of existing two-class classification modules (see FIG. 6) is in that any of the former two-class classification modules contains no minimum value operation unit. This is because the input data D is one, so that there is no need of any minimum value operation unit. In this case, however, one minimum value operation unit per input may be nominally disposed.

In the pattern classifier capable of incremental learning as described above according to the present invention, learning was implemented by using data of the number 7291 of ten types of Arabic numerals from 0 to 9, which have been handwritten wherein a computer of “Ultra 30” manufactured by SUN Co. was used.

As a result, a learning time for dividing all the learning data into the number 9514 of two-class classification problems was 9401 seconds. Moreover, for instance, a time required for learning incrementally the 7292nd input data was 1.45 seconds at the longest.

In the embodiments as described above, a minimum value operation has been conducted first, and then a maximum value operation has been implemented in case of applying the “minimization principle” and the “maximization principle”, which are used in the case where results are collected with respect to problems divided are to be integrated. However, the invention is not limited thereto, but such a manner that a maximum value operation is conducted first, and then a minimum value operation is executed is also applicable.

Since the present invention has been constituted as described above, there is such an excellent advantage to be able to provide a pattern classifier capable of incremental learning by which convergence of learning is guaranteed.

Moreover, since the present invention has been constituted as described above, there is a further excellent advantage to be able to provide a pattern classifier capable of incremental learning in which training time can be remarkably reduced.

It will be appreciated by those of ordinary skill in the art that the present invention can be embodied in other specific forms without departing from the spirit or essential characteristics thereof.

The presently disclosed embodiments are therefore considered in all respects to be illustrative and not restrictive. The scope of the invention is indicated by the appended claims rather than the foregoing description, and all changes that come within the meaning and range of equivalents thereof are intended to be embraced therein.

The entire disclosure of Japanese Patent Application No. 2001-212947 filed on Jul. 13, 2001 including specification, claims, drawing, and summary are incorporated herein by reference in its entirety.

What is claimed is:

1. A pattern classifier capable of incremental learning wherein a multiclass classification problem is divided into two-class classification subproblems, said two-class classification subproblems are further divided into linearly separable classification subproblems, each of which has only two training data belonging to two different classes, the solutions of said linearly separable subproblems are integrated into the solutions of said two-class classification subproblems, and the results obtained by integration of said two-class classification subproblems are integrated into the solutions to said multiclass classification problem, comprising incrementally:
a linearly separable classification means for implementing a linearly separable classification for separating said new training data from the training data that had been learned before inputting said new training data to the pattern classifier; and
an integration means for integrating the classification results of said linearly separable classification means into two-class classification subproblems
in the case when the new training data is added.

2. A pattern classifier capable of incremental learning wherein a multiclass classification problem is divided into two-class classification subproblems, said two-class classification subproblems are further divided into linearly separable classification subproblems, each of which has only two training data belonging to two different classes, the solutions of said linearly separable classification subproblems are integrated into the solutions of said two-class classification subproblems, and the results obtained by integration of said two-class classification subproblems are integrated into the solutions to said multiclass classification problem, comprising incrementally:
a linearly separable classification means for implementing a linearly separable classification for separating said new training data from the training data that had been learned before inputting said new training data;
the first integration means for integrating the classification results of said linearly separable classification means into two-class classification subproblems; and
the second integration means for integrating the results obtained as a result of integration of said two-class classification subproblems by means of said integration means into multiclass classification problems
in the case when the new training data is added.

3. A pattern classifier capable of incremental learning as claimed in claim 1 or 2 wherein,
said new training data is incrementally learned during pattern classification.
